(19) United States
(12) Patent Application Publication
(10) Pub. No.: US 2005/0032974 A1
(43) Pub. Date: Feb. 10, 2005

(54) Adhesion promoter for reactive polyurethanes

(76) Inventors: Michael Krebs, Hilden (DE); Uwe Franken, Dormagen (DE); Katja Brosa, Neuss (DE); Ingolf Scheffler, Neuss (DE)

Correspondence Address: HENKEL CORPORATION, THE TRIAD, SUITE 200, 2200 RENAISSANCE BLVD., GULPH MILLS, PA, 19406, US

(21) Appl. No.: 10/870,344

(22) Filed: Jun. 17, 2004

Related U.S. Application Data
(63) Continuation of application No. PCT/EP02/14057, filed on Dec. 11, 2002.

(30) Foreign Application Priority Data
Dec. 20, 2001 (DE) 101 62 642.8

(51) Int. Cl. C08K 3/00; C08L 75/00

(52) U.S. Cl. 524/589; 528/44

(57) ABSTRACT

Isocyanato-functional silanes prepared by reacting aliphatic or cycloaliphatic polyisocyanates of low volatility with organofunctional silanes containing NCO-reactive groups are useful as adhesion promoters in polyurethane adhesives and sealants.

### CROSS-REFERENCE TO RELATED APPLICATIONS

This application is a continuation under 35 USC Sections 365(c) and 120 of International Application No. PCT/EP02/14057 filed 11 Dec. 2002 and published 3 Jul. 2003 as WO 03/054049, which claims priority from German Application No. 10162642.8, filed 20 Dec. 2001, each of which is incorporated herein by reference in its entirety.

### FIELD OF THE INVENTION

The present invention relates to isocyanato-functional silanes and to their use as adhesion promoters for reactive one- or two-component adhesives/sealants, reactive hotmelt adhesives or solventborne polyurethane adhesives.

### DISCUSSION OF THE RELATED ART

Reactive polyurethane adhesives/sealants, especially one-component moisture-curing systems, generally comprise polymers which are liquid at room temperature and contain urethane groups, possibly urea groups and reactive isocyanate groups. For many applications these compositions are solvent-free and are of very high viscosity and/or pastelike; they are processed at room temperature or at a slightly elevated temperature of between about 50° C. and about 100° C.

Reative, one-component, moisture-curing polyurethane hotmelt adhesives are moisture-curing or moisture-crosslinking adhesives which are solid at room temperature and are applied as an adhesive in the form of their melt, and whose polymeric constituents include urethane groups and also reactive isocyanate groups. The cooling of this melt after application and joining of the substrate parts to be connected results first in a rapid physical setting of the hotmelt adhesive, by means of its solidification. This is followed by a chemical reaction of the isocyanate groups still present with moisture from the immediate environment to form a crosslinked unmeltable adhesive. Reactive hotmelt adhesives based on isocyanate-terminated polyurethane prepolymers are described for example by H. F. Huber and H. Müller in “Shaping Reactive Hotmelts Using LMW Copolymers”, Adhesives Age, November 1987, pages 32 to 35.

Laminating adhesives can either have a construction similar to that of the reactive hotmelt adhesives or are applied as one-component systems from solution in organic solvents; another embodiment is composed of two-component solventborne or solvent-free systems in which the polymeric constituents of one component contain urethane groups and also reactive isocyanate groups and where, in the case of the two-component systems, the second component comprises polymers and/or oligomers containing hydroxyl groups, amino groups, epoxy groups and/or carboxyl group. In these two-component systems the isocyanate-group-containing component and the second component are mixed immediately prior to application, normally with the aid of a mixing metering system.

Reactive polyurethane adhesives/sealants feature a very high performance profile. Consequently, increasingly in recent years, these adhesives/sealants have conquered new applications. Compositions of such adhesives and/or sealants are already known from a very large number of patent applications and other publications.

In order to ensure aging-stable adhesion on numerous substrates, in particular on mineral surfaces, glass or metals, adhesion-promoting substances are added to the polyurethane compositions. It is known to add low molecular weight, organofunctional silanes, such as 3-isocyanatopropyltrimethoxysilane, 3-isocyanatotrieth-oxysilane, 3-methacryloyloxypropylalkoxysilanes, 3-glycidyloxypropylalkoxysilanes, 3-mercaptopropyl-alkoxysilanes, 3-aminopropylalkoxysilanes, 2′-amino-ethyl-3-aminopropylalkoxysilanes or vinylalkoxysilanes, for example; in this regard see, for example, K. L. Mittal (ed.), “Silanes and other Coupling Agents”, commemorative publication in honour of E. P. Plueddemann, 1992, particularly pp. 3-19, 21-47 and 215-228, or in E. P. Plueddemann, “Silane Coupling Agents”, Plenum Press, New York, 1982. As well as in the aforementioned monographs, this approach is described in a multiplicity of patent applications.

Although the addition of low molecular weight, organofunctional silanes of the aforementioned type to polyurethane adhesives and sealants certainly exhibits the desired adhesion-promoting effect, this approach has a number of serious disadvantages. The addition of the aforementioned isocyanato-functional silanes is objectionable on workplace hygiene grounds, particularly in the case of hot-applied polyurethane systems, since these systems are classified as highly toxic on inhalation and may on inhalation give rise to bronchial asthma; that is, may have a sensitizing effect on the respiratory tract. The epoxy-functional, methacryloyl-functional and vinyl-functional alkoxysilanes have only a very limited activity in polyurethane compositions, since they cannot be incorporated into the polyurethane framework of the reactive polyurethanes. Although the mercapto-functional alkoxysilanes are reactive toward isocyanate groups and hence are incorporated into the polyurethane framework, their monofunctionality gives them a chain-terminating effect, and so these compounds have an adverse influence on the strength of adhesives of this kind, particularly when relatively large quantities of adhesion promoter substance have to be added. Owing to their high functionality and their basicity, the use of amino-functional alkoxysilanes leads frequently to stability problems and to gelling during the storage and handling of polyurethane adhesive systems.

JP-10114813 A describes a liquid polyurethane adhesive composition comprising a polyurethane prepolymer containing isocyanate end groups and an adduct of an aminosilane compound or of a mercaptosilane compound with an organic polyisocyanate and also the addition of an epoxysilane compound. These compositions are intended to find use as adhesives, sealants or paints and to have good adhesion to metals, glass, concrete and the like and be stable on storage and to be suitable for the construction industry. That publication does not reveal further applications.

JP-2000128949 A describes one-component liquid polyurethane compositions which are moisture-curing and which comprise a polyurethane prepolymer and a silane compound, the silane compound being said to have 1.5 or more isocyanate groups and 1.5 or more hydrolyzable alkoxy groups per molecule. The silane compound is to be prepared by addition reaction of a polyisocyanate containing 3 or more isocyanate groups per molecule with an alkoxysilane containing secondary amino groups and/or a silane compound with a lysine structure, prepared by addition reaction of lysine diisocyanate containing 2 or 3 isocyanate groups with an aminoalkoxysilane containing secondary amino groups. These compositions are intended to be suitable as sealing material for automotive applications or as coating materials for the construction industry and to exhibit good primerless adhesion and curing properties and resistance to foaming. WO-9836007 Al describes a polyurethane sealant composition for bonding windows in automaking. In addition to a polyurethane prepolymer having an isocyanate functionality of at least 2.0 and an average molecular weight of at least 2000, and a catalyst, these compositions are said to include an adduct of an isocyanate-reactive silane compound and of a polyisocyanate. That document states that this polyurethane sealant composition does not require the application of primer and exhibits effective adhesion to acid-resistant paint surfaces.

It is additionally known to use diisocyanates of higher functionality, such as the biuretization product of hexamethylene diisocyanate (HDI), known as “Desmodur N 100”, from Bayer, with amino-functional silane mixtures as adhesion-promoting components. A disadvantage of this approach is the thermal instability of Desmodur N, which under thermal load of the kind which occurs, for example, during the application of hotmelt adhesives tends toward reverse cleavage to form the highly volatile hexamethylene diisocyanate. Moreover, products of this kind are of very high viscosity and they adversely affect the melt stability of adhesives applied hot or warm, even when added in small amounts of from 0.5% to 2% by weight.

Also known is the use of reaction products of 3-isocyanatomethyl-3,5,5-trimethylcyclohexyl isocyanate (isophorone diisocyanate, IPDI) with amino-functional alkoxysilanes such as 3-aminopropyltriethoxysilane, for example. An advantage of these compositions is their low viscosity, but they cannot be prepared free from monomeric IPDI without great effort. Compositions of this kind are hardly suitable for hotmelt adhesive processing, from a toxicological standpoint, owing to the high IPDI vapor pressure.

### BRIEF SUMMARY OF THE INVENTION

In the light of this prior art the inventors set themselves the object of providing for polyurethane adhesives and sealants adhesion-promoting additives which have a low monomeric isocyanate vapor pressure, possess low viscosity and combine good melt stability with a broad adhesion spectrum.

The inventive achievement of the object is evident from the claims and is based essentially on the provision of reaction products of an aliphatic or cycloaliphatic polyisocyanate of low volatility with an organofunctional silane containing isocyanate-reactive groups which have Zerewitinoff-active hydrogen. The present invention further provides for the use of the so-called isocyanato-functional silanes as an adhesion-promoting additive in polyurethane adhesives and sealants, particularly in laminating adhesives and polyurethane hotmelt adhesives. Of particular suitability are low-monomer-content adhesives as described for example in WO01/40342 and in the documents DE 10132571.1 and DE 10150722.4, unpublished at the priority date of the present specification.

### DETAILED DESCRIPTION OF CERTAIN EMBODIMENTS OF THE INVENTION

The polyisocyanate “of low volatility” that is used to prepare the isocyanato-functional silane of the invention is intended to have a substantially lower vapor pressure than the IPDI; in other words, the vapor pressure of the polyisocyanate ought to be less than 5×10⁻⁵ hPa at 20° C. The compounds in question may in accordance with the invention comprise a diisocyanate of low volatility such as dimer fatty acid diisocyanate or 1,12-dodecane diisocyanate or polyisocyanates having a higher functionality and/or higher molecular weight; preferably the polyisocyanates with a molecular weight below about 800 have 3 isocyanate groups per molecule.

The organofunctional silanes suitable for the reaction ought to have a functionality of less than or equal to 1.3, preferably less than or equal to 1.2, with respect to the polyisocyanate. Suitable NCO-reactive groups for the organofunctional silane include hydroxyl groups, preferably mercapto groups and, with particular preference, secondary amino groups.

A suitable polyisocyanate for use is the isocyanurate of hexamethylene diisocyanate, known for example under the trade name “Desmodur N 3300” from Bayer; additionally suitable in principle are the isocyanuratization products of other aliphatic and cycloaliphatic diisocyanates such as of IPDI, known for example under the tradename “IPDI-T 1890” from Degussa-Huls, or else adducts of aliphatic or cycloaliphatic isocyanates with low molecular weight triols or else with diols having a molecular weight of below 2000, preferably below 1000. Adducts of this kind are high molecular weight polyisocyanates; their use as starting material for adhesive and sealant binders is described in WO01/40342; the high molecular weight diisocyanates described therein are extremely suitable for reaction with the aforementioned organofunctional silanes. Although the aforementioned isocyanurates or high molecular weight polyisocyanates generally still contain traces of the starting isocyanates used for the synthesis, the principal product meets the inventive criterion of low volatility. The vapor pressure specifications presented above therefore relate to the main product and not to the impurities in the case of the isocyanurates, adducts and high molecular weight diisocyanates.

Examples of suitable cycloaliphatic polyisocyanates are the hydrogenation products of aromatic diisocyanates such as 4,4′-dicyclohexylmethane diisocyante (H₁₂MDI), 1-isocyanatomethyl-3-isocyanato-1,5,5-trimethylcyclohexane (isophorone diisocyanate, IPDI), cyclohexane 1,4-diisocyanate, hydrogenated xylylene diisocyanate (H₆XDI), 1-methyl-2,4-diisocyanato-cyclohexane, m- or p-tetramethylxylene diisocyanate (m-TMXDI, p-TMXDI) and dimer fatty acid diisocyanate. Examples of aliphatic polyisocyanates are tetramethoxybutane 1,4-diisocyanate, butane 1,4-diisocyanate, hexane 1,6-diisocyanate (HDI), 1,6-diisocyanato-2,2,4-trimethylhexane, 1,6-diisocyanato-2,4,4-trimethylhexane, lysine diisocyanate and also 1,12-dodecane diisocyanate (C₁₂DI).

Particularly suitable triols include trimethylolpropane and glycerol, as diols either α,ω-alkanediols or polyethylene glycols, polypropylene glycols or polyester diols having a molecular weight of below 2000, preferably below 1000.

Suitable organofunctional silanes in addition to the aforementioned hydroxy-functional silanes include in particular 3-mercaptopropyltriethoxysilane, 3-mercapto-propyltrimethoxysilane, 3-mercaptopropylalkyldiethoxy-silane and also, in particular, N-(n-butyl)-3-amino-propyltrimethoxysilane, N-(n-butyl)-3-aminopropyltri-ethoxysilane, N-(n-butyl)-3-aminopropylalkoxydiethoxy-silane and also bis(3-triethoxysilylpropyl)amine and also the corresponding alkyldiethoxysilyl derivative of the last-mentioned silane.

Although it is preferred to use secondary aminosilanes alone it is also possible to employ mixtures, although they ought to contain at least 70% by weight, preferably over 80% by weight, of secondary aminosilane.

The isocyanato-functional silanes of the invention are particularly suitable as adhesion-promoting additives for polyurethane hotmelt adhesives, since they have no volatile constituents and in particular no toxic volatile constituents, but they can also be used as adhesion-promoting additives in sealants, laminating adhesives and coating materials. They are particularly suitable for those applications where no complex ventilation devices are available; in other words, for example, in the craft and consumer sectors. Their addition to the adhesives enables adhesive formulations having a broad adhesion spectrum which embraces even difficult-to-bond substrates such as metals, mineral substrates or glass, for example, and also a host of plastics. Polyurethane hotmelt adhesive compositions comprising the silane additives of the invention exhibit high thermal stability and stability of viscosity in the melt.

The adhesive or sealant compositions contain normally from 0.1% to about 5% by weight, preferably between 0.5% and 2% by weight, of the isocyanato-functional silane of the invention.

The invention is illustrated in the working examples below; the selection of the examples is not intended to constitute any restriction on the scope of the subject matter of the invention, the examples being intended merely to illustrate modelwise certain embodiments and advantageous effects of the invention. All of the amounts given in the examples below are parts by weight or percentages by weight, unless stated otherwise.

### EXAMPLES

### Example 1

59 parts by weight of an isocyanuratized hexamethylene diisocyanate (MW 504.6 g/mol, equivalent weight 183 g/mol, residual monomeric HDI content less than 0.2%) were reacted with 41 parts by weight of N-(n-butyl)-3-aminopropyltrimethoxysilane to constant isocyanate content. The viscosity of the reaction product is 1.7 Pas at 60° C. This silane adduct was melt-stable as a substance at 60° C. for over 16 hours. Its handlability at room temperature was excellent.

### Example 2

### Comparative

Along the lines of the teaching of WO9836007, 69 parts by weight of IPDI and 31 parts by weight of a customary, commercially available aminosilane based on bis(3-triethoxysilylpropyl)amine (containing 40% bis(3-triethoxysilylpropyl)amine and 60% 3-aminopropyltrieth-oxysilane) were reacted to constant isocyanate content. The product was an isocyanato-functional silane adduct of high viscosity having an NCO content of 20% and a viscosity of 1 Pa·s at 20° C. The IPDI monomer content of the formulation was about 35%. This customary adhesion promoter is extremely melt-stable at 60° C.; over the course of 7 hours the viscosity rose from 150 mPas to 200 mPas, in other words by approximately 30%. As a substance, i.e., without the high excess of monomeric IPDI, however, this silane adduct was less melt-stable. At 130° C. the viscosity rose over the course of 6 hours from 16 Pas to 91 Pas, in other words by 470%.

### Example 3

In accordance with the teaching of the as yet unpublished DE 10150722.4, 86.40 parts of a mixture of amorphous and crystalline polyesters liquid at room temperature and with an average OHN of 40.8 and 12.57% parts of 2,4′-MDI (purity greater than 97%) were used to prepare a hotmelt adhesive. 1.03 parts of the silane adhesion promoter from example 1 were added to this hotmelt adhesive. The viscosity at 130° C. was 6500 mPas (Brookfield viscometer with Thermosel). The hotmelt adhesive displayed good melt stability and processing properties. After 6 hours at 130° C. a viscosity increase of only 100% was found.

### Example 4

### Comparative

The procedure of example 3 was repeated but using the silane adhesion promoter from example 2. The viscosity rose by 450% after 6 hours at 130° C.

To test the adhesion properties of the adhesive formulations from examples 3 and 4 substrates were selected which are difficult to bond with aging stability using customary polyurethane hotmelt adhesives.

After 7-day curing of the bonded substrates at room temperature the test specimens were subjected to a four-day climatic switching test such as is customary in the automotive industry (in accordance with VW P 1200 standard).

| | |
|---|---|
| Glass | + |
| V2A steel | + |
| Plain Alu 99.5 | +/− |
| Plain steel (ST37) | +/− |
| PMMA | + |
| PC | + |
| PS | + |
| uPVC | + |
| PA 6.6 natural | + |

The adhesion tests led to equally good results in both cases, but the hotmelt adhesive of the invention had a substantially higher melt stability and did not exhibit any emission of highly volatile monomeric isocyanate nor any reverse cleavage to form a highly volatile isocyanate, so that from a workplace hygiene standpoint as well the hotmelt adhesive of the invention has the better properties.

1. An isocyanato-functional silane obtained from an aliphatic or cycloaliphatic polyisocyanate of low volatility and an organofunctional silane having NCO-reactive groups containing Zerewitinoff-active hydrogen.

2. The isocyanato-functional silane of claim 1, wherein the polyisocyanate has a vapor pressure of less than 5×10⁻⁵ hPa at 20° C.

3. The isocyanato-functional silane of claim 1, wherein the organofunctional silane has a functionality of less than or equal to 1.3 with respect to the polyisocyanate.

4. The isocyanato-functional silane of claim 1, wherein the polyisocyanate is selected from the group consisting of isocyanurate of hexamethylene diisocyanate (HDI), isocyanurate of isophorone diisocyanate (IPDI), and adducts of aliphatic or cycloaliphatic diisocyanates and low molecular weight triols, and mixtures thereof.

5. The isocyanato-functional silane of claim 1, wherein the organofunctional silane contains at least one NCO-reactive group per molecule selected from the group consisting of hydroxyl, mercapto and secondary amino groups.

6. The isocyanate-functional silane of claim 1, wherein the organofunctional silane contains a secondary amino group.

7. The isocyanate-functional silane of claim 1, wherein the organofunctional silane is selected from the group consisting of N-(n-butyl)-3-amino-propyltrimethoxysilane, N-(n-butyl)-3-aminopropyltriethoxysilane, N-(n-butyl)-3-aminopropylalkoxydiethoxysilane, bis(3-triethoxysilylpropyl)amine and bis (alkyldiethoxysilyl)amines.

8. A method of improving the adhesion of a polyurethane adhesive or sealant to a substrate, said method comprising incorporating an isocyanato-functional silane in accordance with claim 1 into said polyurethane adhesive or sealant.

9. The method of claim 8, wherein said polyurethane adhesive or sealant is a hotmelt adhesive.

10. The method of claim 8, wherein said polyurethane adhesive or sealant is a laminating adhesive.

11. The isocyanato-functional silane of claim 1, wherein the aliphatic or cycloaliphatic polyisocyanate of low volatility has a vapor pressure of less than 5×10⁻⁵ hPa at 20° C. and is selected from the group consisting of dimer fatty acid diisocyanates, 1,12-dodecane diisocyanate, isocyanurate of hexamethylene diisocyanate (HDI), isocyanurate of isophorone diisocyanate (IPDI) and adducts of aliphatic or cycloaliphatic diisocyanates and low molecular weight triols.

12. The isocyanato-functional silane of claim 11, wherein the organofunctional silane has a functionality of less than or equal to 1.3 with respect to the polyisocyanate.

13. The isocyanato-functional silane of claim 11, wherein the organofunctional silane contains at least one NCO-reactive group per molecule selected from the group consisting of hydroxyl, mercapto and secondary amino groups.

14. The isocyanate-functional silane of claim 11, wherein the organofunctional silane contains a secondary amino group.

15. The isocyanate-functional silane of claim 11, wherein the organofunctional silane is selected from the group consisting of N-(n-butyl)-3-amino-propyltrimethoxysilane, N-(n-butyl)-3-aminopropyltriethoxysilane, N-(n-butyl)-3-aminopropylalkoxydiethoxysilane, bis(3-triethoxysilylpropyl)amine and bis (alkyldiethoxysilyl)amines.

16. A method of improving the adhesion of a polyurethane hotmelt adhesive to a substrate, said method comprising incorporating an isocyanato-functional silane in accordance with claim 11 into said polyurethane hotmelt adhesive.

17. A polyurethane adhesive or sealant comprising an isocyanato-functional silane in accordance with claim 1.

18. The polyurethane adhesive or sealant of claim 17, wherein said isocyanato-functional silane comprises from 0.1% to 5% by weight of the polyurethane adhesive or sealant.

19. A polyurethane hotmelt adhesive comprising an isocyanato-functional silane in accordance with claim 11.

20. The polyurethane hotmelt adhesive of claim 19, wherein said isocyanato-functional silane comprises from 0.5% to 2% by weight of the polyurethane hotmelt adhesive.
